(19) United States
(12) Patent Application Publication
(10) Pub. No.: US 2010/0312668 A1
(43) Pub. Date: Dec. 9, 2010

(54) METHODS AND SYSTEMS PRODUCING RELIABLE PERSONALIZED ADAPTIVE INFORMATION REGARDING PRODUCTS

(75) Inventor: Nadav Yehuda Notsani, Tel Aviv (IL)

Correspondence Address: Nadav Yehuda Notsani, Brener 15 apt.2, Tel-Aviv, 63826, omitted

(73) Assignee: Nadav Yehuda Notsani, Tel Aviv (IL)

(21) Appl. No.: 12/794,573

(22) Filed: Jun. 4, 2010

Related U.S. Application Data
(60) Provisional application No. 61/183,993, filed on Jun. 4, 2009.

(51) Int. Cl. G06Q 30/00

(52) U.S. Cl. 705/26.63

(57) ABSTRACT

A method and system producing reliable personalized aduptive information regarding products for a decision instance. In a preferred embodiment food products alternatives are automatically compared.

### CROSS REFERENCE TO RELATED APPLICATIONS

This application claims the benefit of provisional patent Ser. No. 61/183,993 filed Jun. 4, 2009 by the present inventor.

### FIELD OF THE INVENTION

The present invention relates generally to methods and systems providing users with personalized information regarding products and services.

### BACKGROUND OF THE INVENTION AND PRIOR ART

Different people have different tastes and needs regarding products and services purchases and consumption. For example, some people have specific dietary needs, others may have ideological inclinations, others require special quality assurances, etc. Different people may also trust different sources of information such as government authorities, experts, organizations or personal acquaintances. The purpose of this invention is to provide each user with the specific information received from specific sources as to meet his individual preferences regarding the products of interest.

We will consider as an example for the above, the instance of a diabetic person which has to decide whether to purchase a certain food product. Today, such a person would have to check for a diabetic certification symbol on the product's label, since sugar content and glycemic value are not commonly noted. This poses a few problems, for example, the certification symbol does not take into consideration potentially harmful ingredients such as fats, the product may contain a small amount of sugar yet it will not be certified since the certification has a dichotomic value.

Using the suggested system and method, during setup, the above user will choose specific information about diabetes from trusted sources. When contemplating a purchase of a food product, the user may take the product off the shelf, scan its barcode and receive full personalized information regarding the specific extent of the effects of relevant products on the person, for example one gram of sugar has a different effect as compared to 25 grams of sugar. Another example would be a person which requires an evaluation of environment-friendliness of products as certified by the Greenpeace organization.

Current application product scanning that results in displaying standard data regarding the product (nutritional values, serving size etc.). This information is not weighed into personal value that enables the user and the system to compare products easily or automatically.

### SUMMARY OF THE INVENTION

A purchase or consumption decision (hereinafter Decision) is defined by the user's temporary and permanent preferences (hereinafter Preferences) and the alternative set relevant at the location and time (hereinafter Location). An alternative can be a product or a service (hereinafter Product). A principal intention of the present invention includes a system and software interface supplying personally tailored products evaluations for user decision, from a preferred source, regarding decision instance alternatives, with maximum simplicity and rapidity, anywhere, anytime at a minimal cost, using existing, commonly-used hardware, saving time and minimal habit change. For example, a user scans a chocolate flavored cereal. The system can deduce that the user is looking for a similar product (chocolate flavored cereal) in the current supermarket inventory that is most suitable for his Preferences (such as health implications, taste, simplicity, ideology etc.). Another example would be a decision which recipe to consume at home. Another decision would be what cigarette or microwave to buy.

According to variations of the present invention, there is provided a method for evaluating the nutritional value advantages and disadvantages food items, adaptive to the nutritional constraints of a user, such as health constraints, diet program, etc.

According to the teachings of the present invention there is provided client-server system including: client software and a central database with a management unit. The database unit typically includes a products' database, a users' database and other databases.

### BRIEF DESCRIPTION OF THE DRAWINGS

The present invention will become fully understood from the detailed description given herein below and the accompanying drawings, which are given by way of illustrations and examples only and thus not limitative of the present invention, and wherein:

FIG. 1 is an example block diagram of system supplying Tailored Products information for user Decision, according to embodiments of the present invention;

FIG. 2 is a schematic flow chart showing an example method retrieving Tailored Products information for user Decision, according to embodiments of the present invention;

FIG. 3 is a schematic flow chart showing an example method retrieving Tailored Products information for user Decision, according to embodiments of the present invention;

FIG. 4 is a schematic flow chart showing an example method of computing setup of user Preferences algorithm, according to embodiments of the present invention;

FIG. 5 is a schematic flow chart showing an example method of computing Products Tailored evaluations alternatives to store in the User's DB, according to embodiments of the present invention;

FIG. 6 is an example diagram of a mobile device display, according to embodiments of the present invention;

FIG. 7 is an example block diagram of relations between objects related to product DB and user DB, according to embodiments of the present invention;

FIG. 8 is an example block diagram of system relations between objects related to Product evaluators, according to embodiments of the present invention;

FIG. 9 is a schematic flow chart showing an example method searching for relevant trusted sourced attributes, according to embodiments of the present invention;

FIG. 10 is a schematic flow chart showing an example one click method retrieving Tailored Products information for user Decision, according to embodiments of the present invention;

FIG. 11 is a schematic flow chart showing an example method of producing Alternatives sets with regard to advertisement, according to embodiments of the present invention;

FIG. 12 is a schematic flow chart showing an example method producing and checking Tailored shopping list, according to embodiments of the present invention;

FIG. 13 is a schematic flow chart showing an example method acquiring personal taste indication sourced attributes, according to embodiments of the present invention;

FIG. 14 is a schematic flow chart showing an example method computing recipe attribute values, according to embodiments of the present invention;

FIG. 15 is an example block diagram of system enabling mobile phone camera to capture barcode, according to embodiments of the present invention;

FIG. 16 is a schematic flow chart showing example methods obtaining input parameters dynamically at query time or statically on setup, according to embodiments of the present invention.

FIG. 17 is a table diagram showing examples of criteria and corresponding information sources, according to embodiments of the present

### DETAILED DESCRIPTION OF THE PRESENT INVENTION

Before explaining embodiments of the invention in detail, it is to be understood that the invention is not limited in its application to the details of construction and the arrangement of the components set forth in the host description or illustrated in the drawings. Unless otherwise defined, all technical and scientific terms used herein have the same meaning as commonly understood by one of ordinary skill in the art to which the invention belongs. The methods and examples provided herein are illustrative only and not intended to be limiting.

By way of introduction, a principal intention of the present invention includes a system and software interface supplying tailored products information for user decision. The invention will now be described in terms of a system and method for providing tailored products information for user decision.

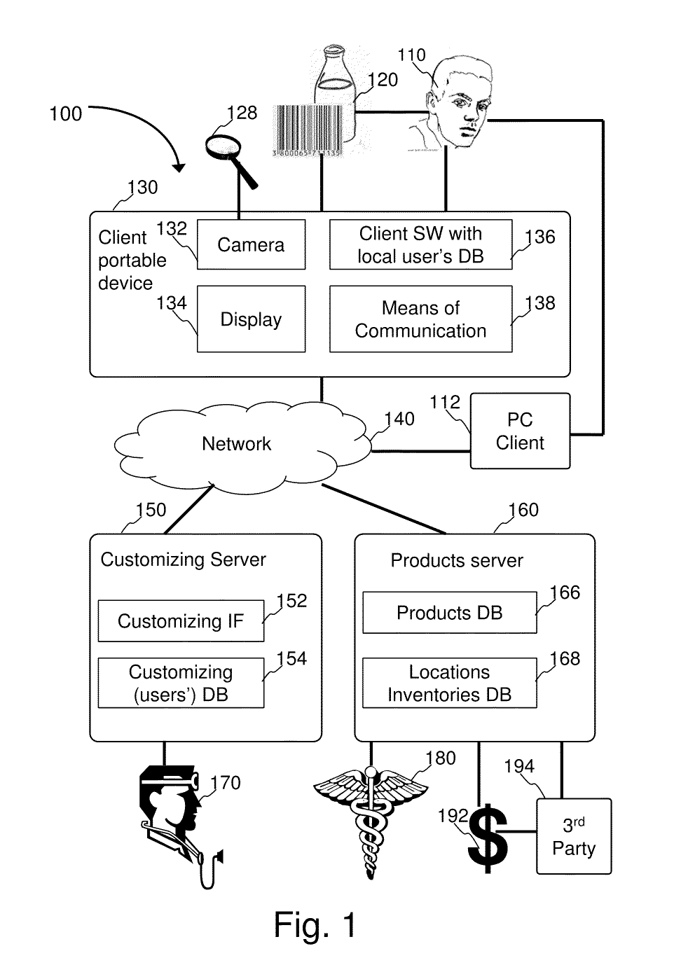

FIG. 1 is an example block diagram of system 100 supplying Tailored Products information for user 110 Decision anchor 120, according to embodiments of the present invention.

User 110 uses Client mobile device 130 such as a mobile phone or a PDA or any other device with input, display, and ability to connect to Network 140 to identify Decision anchor 120 and may use Capture aid 128. Client mobile device 130 comprising Camera 132 or other means of input, means of Display 134 Client SW with local user's DB 136 Means of Communication 138. User 110 may also use PC Client 112 for setups and offline decisions requiring a larger interface. Customizing expert 170 such as User's health insurer or medical doctor or dietician uses Customizing IF 152 to set up an update and supervise his users 110 In the

Customizing DB 154 residing on Customizing Server 150 health data is securely stored in Customizing Server 150. Products server 160 comprises Products DB 166 and Locations Inventories DB 168. Product evaluator 180 evaluates products in the Products DB 156. Product Advertiser 192 may connect to the Products server 160 directly or through 3^{rd} Party 194 to promote product or to compare purchase data with system 100 use.

Embodiment of system 100 may be a portable devise 130, which may include means such as input means 132, display means 134, computation means, dedicated software 136, memory and means of communications 138. Remote computers 150 include databases, customizing interface 152, means of communication with portable device. Databases 136, 154, 166, 168 are updated as result of change in data such as new records of users behaviors, changes in locations inventories, changes in src-attibs etc. Remote computers 150 may be used for at least user setup and update and to send part of the results to portable device 130. Portable device 130 may be used by user 110 to obtain decision identifiers 310, extract tailored alternatives evaluations 320 and display personalized evaluation of alternatives 330. Remote computers 150 may include customizing expert interface 152. Database may include user database 136, estimated locations inventory database 168, users' database 154, sourced-attributes database as part of the products database 166. Interface may include customizing expert's interface 152, product evaluators 180 interface, user's 110 interface, advertisers 192 interface. Remote computers 150 may also return online information as a result of decision identifiers sent by said portable device 130.

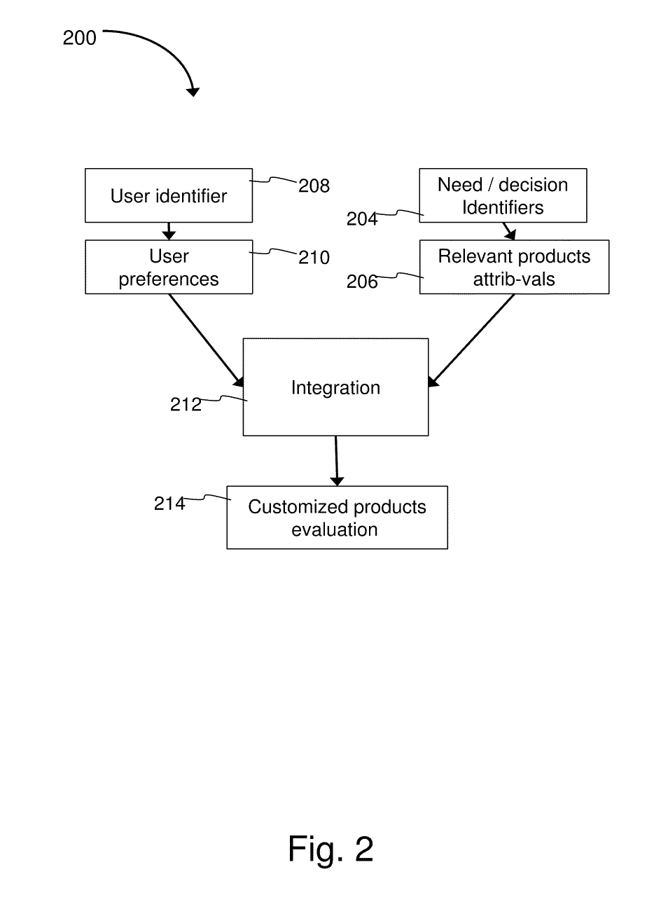

FIG. 2 is a schematic flow chart showing example method 200 retrieving Tailored Products information for user Decision, according to embodiments of the present invention.

The method 200 uses Need/decision Identifiers 204 such as Decision anchor 120, location and time to determine and retrieve relevant products attrib-vals 206. The method 200 uses User identifier 208 to retrieve User preferences 210 Algorithm. User preferences 210 Algorithm and decision Identifiers 204 are used to integrate 212 relevant products attrib-vals 206 to evaluate Tailored customized products evaluation 214.

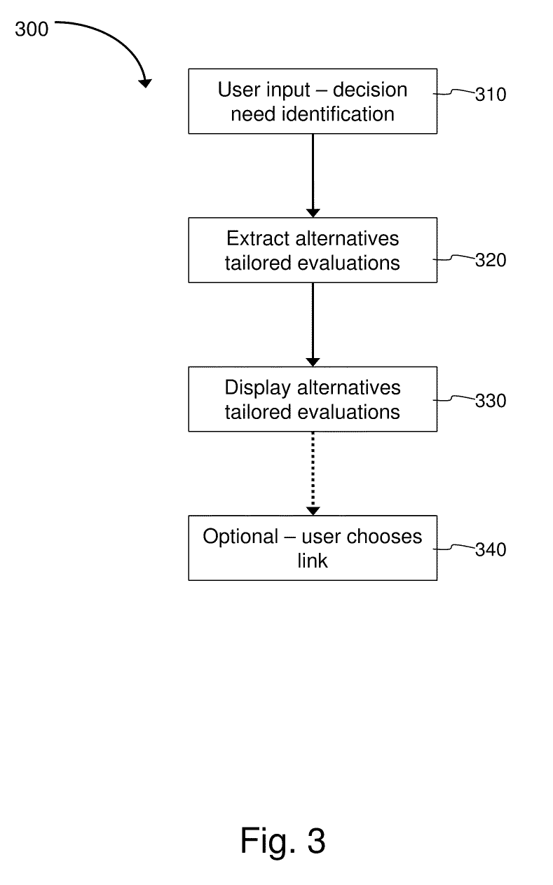

FIG. 3 is a schematic flow chart showing example method 300 retrieving Tailored Products information for user Decision, according to embodiments of the present invention;

User 110 inputs decision need identification 310 comprising location and Decision anchor 120 and other dynamic or static parameters, enabling method 300 to extract alternatives Tailored evaluations 320 from the local (or remote) user's DB 136. Method 300 Displays decision Tailored alternatives evaluations 330. User 110 can than choose link 340 in order to get further information, choose a product to save or purchase.

In some embodiment of method 300 of providing tailored alternatives evaluations 330 to a user regarding said decision instance which may include a portable device 130 containing input means 132, communication means 138, display means 134 and computational abilities 136. Then obtaining decision identifiers 310 which comprise of location, anchor and User identifier. Extracting tailored alternatives evaluations 320, which are expected to be available in location inventory, substitution to anchor, alternatives' attributes and meeting user preferences. Substitution values may be acquired from a product substitution survey, that can be visualized as similar to visual “Thesaurus” where a distance is estimated between each tow nodes. The substitution value can be general, users cluster personalized or single user personalized. Displaying personalized evaluation of alternatives 330 is calculated using user preferences adapted to decision situation.

Prior setup 400 using user attributes results in user preferences. The location identifier is automatically acquired, in means such as mechanical locator (such as GPS), recent location, expected location according to time (example 1 AM at home). Location can be inputted by user such as choices from frequent location list or typing first letters, etc.

An anchor may a food product. An anchor may be automatically acquired by use of time, place or regular habits. Regular habits that can help obtain anchor may be: Meal times, in the example of nutrition regular habits may be meal times, insulin injection times.

An anchor may be acquired using input means, such as means of recognition of image from camera, voice recognition, text typing or choice from list. An anchor may be a product barcode such as USDA nutritional database identifier. Displayed personalized evaluation may be a tailored evaluation. Displayed information 330 may include links 340 to further operations on alternatives such as receiving detailed information, alternative's detailed information, choosing and alternative or purchasing. Setup may be done by customization expert 170. Customization expert 170 may be a health expert such as health insurers, health providers, other health organizations, medical doctors, dietitians, health leaders. Customization expert may have access to it's users behaviors recording done by the system or to the it's users preferences and it's results such as changes in medical indices. The access to the data will enable the customization expert to monitor it's users and perform automatic clinical surveys benefiting from the vast serial data for each user. The experiment results can be used on personal or aggregated basis.

In preferred embodiment Setup 400 and 500 may be done automatically or semi automatically using existing user's 110 computerized data that is available to the customization expert 170, where part the data remains only available to the customization expert 170. Setup 400 and 500 can be done automatic by computer where the algorithm of turning users' attributes that reside on the customizing expert's computer into users' preferences including expected frequent locations. An example of semi automatic setup is when a medical doctor or dietitian uses the existing data with or without further information from user to setup the preferences. Frequent location may be determined automatically by recording places that the portable device stops in frequently. User preferences is an algorithm that estimates the influences of the product attributes on the user's utility.

Preferences 420 include updatable user's database 550, part of user's database 136 is sent to the portable device 130. The portable user's database 136 may include expected frequent locations estimated inventories. User attributes may remain secret, accessible only to the executor of the said setup. Food attributes may include macronutrients quantities, salt quantities, emphasis would be on excess rather than on deficiency. Evaluations 418 may estimate the effect of the attributes on health benefit of users suffering from problems such as diabetes, overweight, cardio vascular disorders. Personalized evaluation may be personalized to a cluster of users.

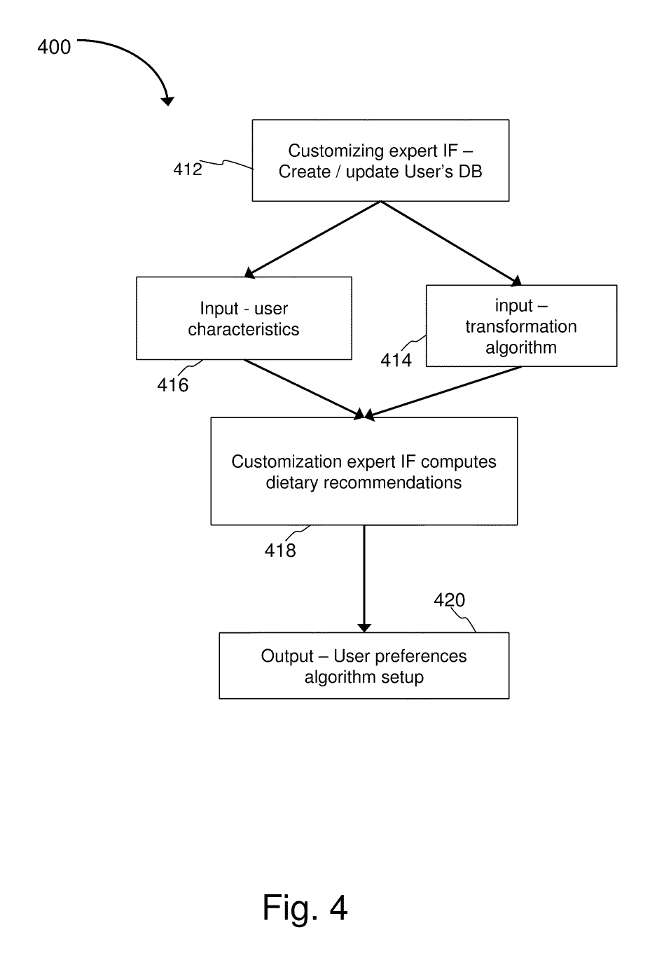

FIG. 4 is a schematic flow chart showing an example method 400 of computing setup of user Preferences algorithm, according to embodiments of the present invention. Customizing expert 170 executes method 400 Customizing expert IF 152 in order to Create or update User's DB 412. Customizing expert 170 inputs user characteristics 416 and transformation algorithm 414. Customization expert IF computes dietary recommendations 418 and Outputs User preferences algorithm setup 420. Transformation algorithm 414 can be determined by choosing src-attribs 818 automatically semi-automatically or manually.

Input—user characteristics 416 such as health parameters, habits, stores, restaurants, recipes and behavior history. User characteristics 416 may include: Sex, age, height, weight, blood tests results, health condition (diabetes, blood pressure, overweight, cardiovascular diseases etc.), medicine use and times, special sensitivities, desired weight change pace, physical activity (can be calculated by general activity factor or by calculation of duration multiplied by activity type), role in family nutrition, genetic health history, times of waking up and going to sleep, times of meals and meal content, stores and restaurants often visited, often used products, often chosen restaurant dishes, home recipes, nutritional behavior—expected behavior using the software (scan every consumption or scan new products only etc.), fat/muscle percentage etc. When Customizing expert 170 is health insurer it can use its customers DB to automatically input user characteristics 416 and use it's experts to determine transformation algorithm 414 making method 400 automatic and reliable (to insurer and customer). This also prevents exposure of the heath data in the insurer's DB. The insurer will also benefit deduction in heath suites, better supervision, service and public image.

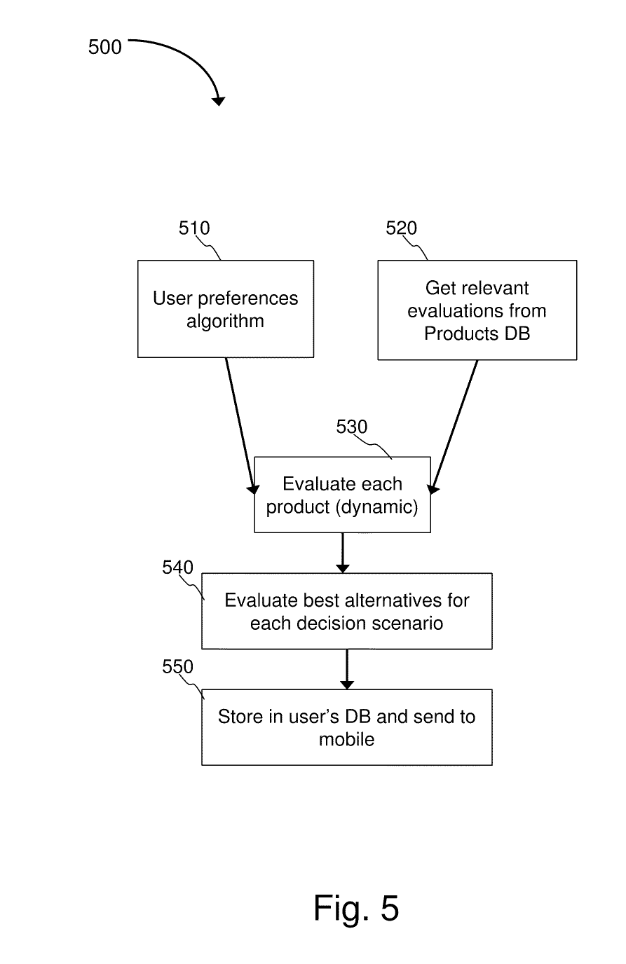

FIG. 5 is a schematic flow chart showing an example method 500 of computing Products Tailored evaluations alternatives to store in the User's DB, according to embodiments of the present invention. The inputs of method 500 comprise User preferences algorithm 510 and relevant evaluations from Products DB (By locations inventories, relevant attrib-vals) 520 the method 500 evaluate each product (dynamic) 530 for each decision scenario

Evaluate best alternatives for each decision scenario 540. The result is stored in user's DB and sent to mobile 550. An example of computing User preferences algorithm 510 is shown in method 400. Evaluation for each decision scenario 540 can be an estimation that will be completed by the algorithm when the actual dynamic parameters are used at decision instance.

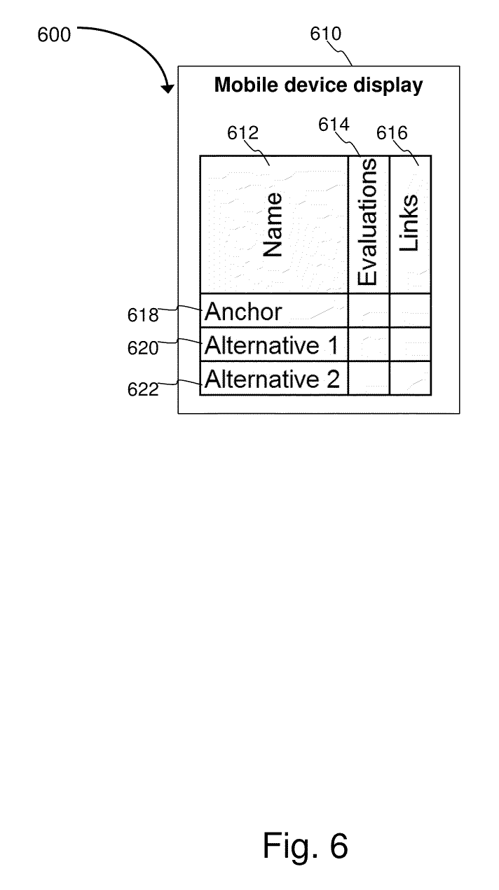

FIG. 6 is an example diagram 600 of a mobile device display, according to embodiments of the present invention. This Mobile device display 610 displays one or more alternatives. In the example there are three alternatives—the Anchor 618 such as the scanned product, and similar more suited alternatives, Alternative 1 620 and Alternative 2 622. For each alternative its Name 612 Evaluations 614 Links 616 are displayed. Links 616 may lead to further information or decision execution (purchase, save, evaluate). Evaluations 614 can be various. They may be by the user or an acquaintance of the user. In a preferred embodiment, evaluations 614 would be calculated to produce values that will enable comparison and further calculations. There can be one or more evaluations 614.

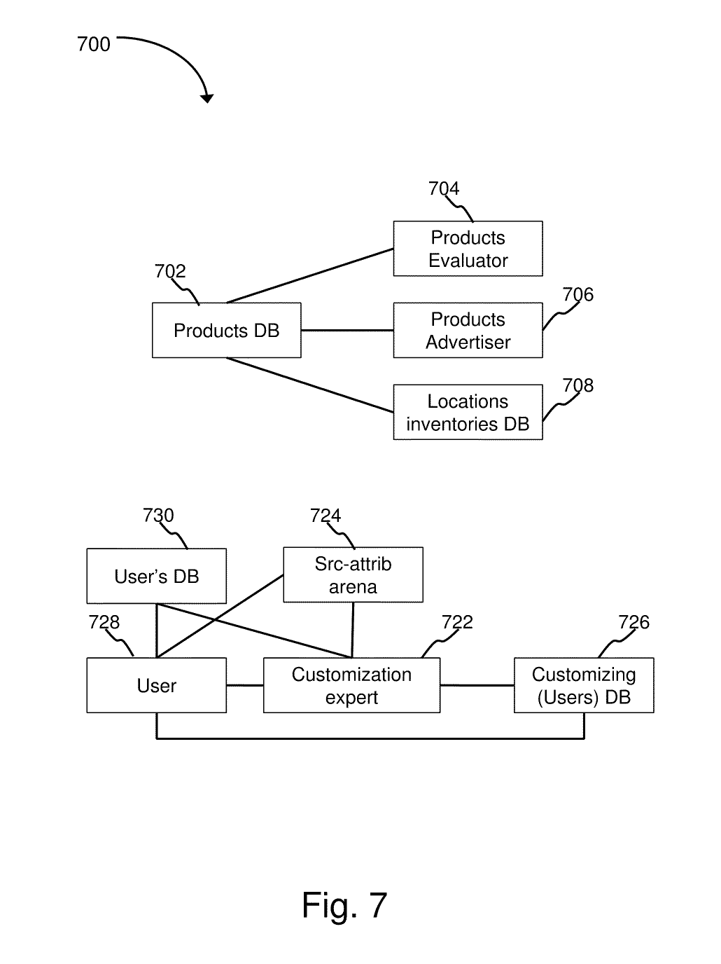

FIG. 7 is an example block diagram 700 of relations between objects related to product DB and user DB, according to embodiments of the present invention. Products DB 702 is used and influenced by Products Evaluators 704 Products Advertisers 706. Products DB 702 includes or is connected to locations inventories DB 708 (such as store, restaurant (preferably part of a chain, home and work). Customization expert 722 creates user's DB 730 that is stored in his users DB 726 and provided to User 728. Src-attrib arena 724 is accessible to Customization expert 722 and User 728 to acquire src-attribs and comment.

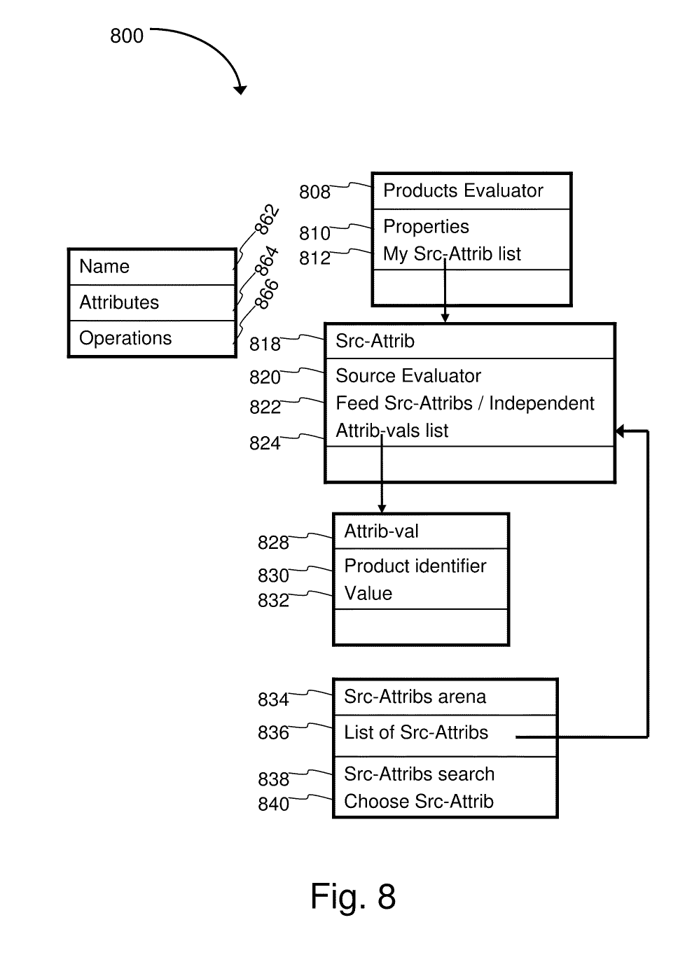

FIG. 8 is an example block diagram of system 800 relations between objects related to Product evaluators, according to embodiments of the present invention;

Each object representation in the diagram comprise three parts: the top rectangle is it's Name 882 the middle rectangle is it's attributes 884 and the lower rectangle is it's operations 886. An arrow represents pointing. The object named products evaluator 808 comprises of Properties 810, such as Identifiers and relations, and user owned Src-attrib list 812 where each item points to Src-attrib 818 object. The object named Src-attrib 818 comprises of source evaluator 820, list of feeding Src-Attribs algorithm 822, and Attrib-vals list 824 that contains values for some products that have identifiers in the system 800. Attrib-vals list 824 can also be an algorithm that results in values for some products. The object named Attrib-val 828 comprises of product identifier 830 and value 832 In a preferred embodiment the values 832 may be suitable for further calculations. A numeric value 832 may be expected to indicative (9.2 in 0 to 10 scale is not necessarily better then 9 but is almost certainly better then 5). The object named Src-attribs arena 834 comprises of list of Src-attribs 836 from a variety of products evaluators 808, the operations Src-attribs search 838 and Chosen Src-Attrib 840 for further use. Most information regarding products is yet unavailable in most required, by users, formats. In order to enable creation and gathering information in the required formats a preferred embodiment of system 800 along with method 900 offers an unnatural evolution like method to enable creation of required information and testing it. A primary intention of this system is to help accumulate, emphasize, duplicate and create information regarding products that is relevant to and trusted by entities. In general information should be filtered by relevancy to goals, accuracy. Accuracy can be tested by format of information and it's source which should have the knowledge and interest to supply accurate information. The system 800 uses list of unique identifiers that include barcodes such as UPC and identifiers from the USDA nutritional DB. The place of the surviving genes sequence is replaced by src-attrib 818 that includes header, list of attrib-vals 828 for some products. Each attrib-val 828 is a product identifier and a value assigned to it, in preferred embodiments the value should be an estimation and should enable further calculation using it. A header 820 and 822 may include: source evaluators 820, claimed essence, creation feeds algorithm 822 and relations. source evaluators 820 an entity that managing it, for example Greenpeace, group of medical doctors or an anonymous user. Claimed essence (examples: sugar content of food, life expectancy of electric product, damage level to diabetics). creation feeds algorithm 822 specifies how the values were calculated from which sources, if no sources are declared it is independent, the algorithm 822 can be private or public. if the algorithm 822 excepts variable parameters, such as user's Hb.A1C value, than the it's attrib-vals are calculated for in respect to them. Relations of src-attrib 818 are it's credentials and should contain general popularity or grading, accreditations by other entities. To enable the unnatural selection and duplication a src-attrib arena 834 is provided with operations on the set of src-attribs 836 such as search 838, use 840 in preferences setup method 400, use 840 to calculate further src-attrib 818, compare with other src-attribs and create connection. Create connection enables to certify or comment on the src-attrib 818. Search 838 operation will be able to use temporary search parameters, such as “diabetes” or “stimulation”, and relations of each src-attrib 818 entity to provide the approximated relevant alternatives sorted. Src-attrib arena 834 provides remote interfaces to be used by users 110, customizing experts 170 and product evaluators 180 in their location using a personal computer equivalent.

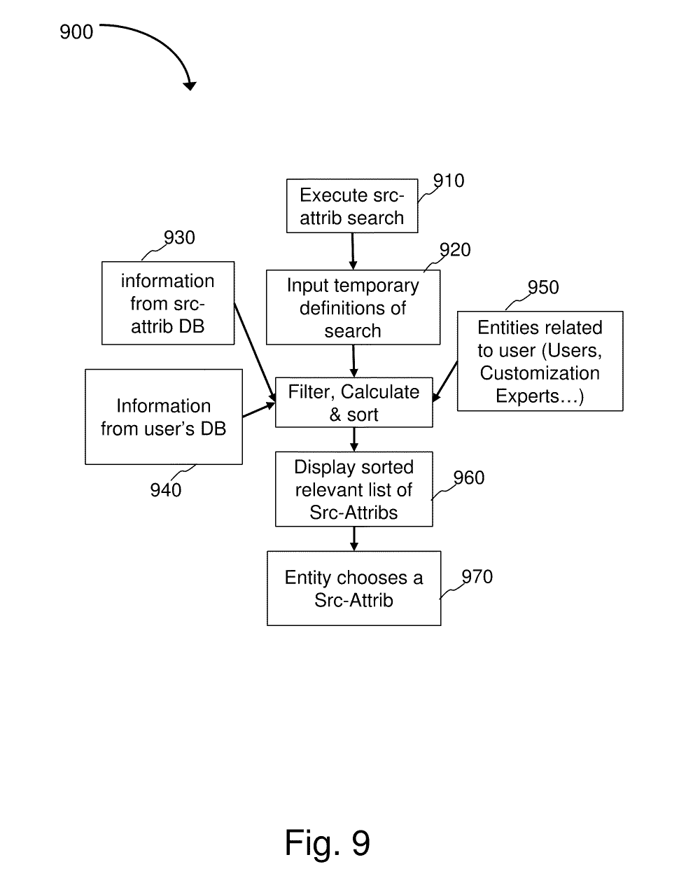

FIG. 9 is a schematic flow chart showing an example method 900 searching for relevant trusted sourced attributes, according to embodiments of the present invention;

Customizing expert 170 User 110 or other entity executes a src-attrib search 910, the entity inputs temporary definitions of search 920, at this stage additional information that comprises of information from src-attrib DB 930, Information from user's DB 940, information from entities related to user (Users, Customization Experts etc.) 950 is used to Filter, Calculate & sort 960 src-attribs 818. a sorted relevant list of Src-Attribs 970 is displayed and the entity chooses a Src-Attrib 980 and views it's details or uses it.

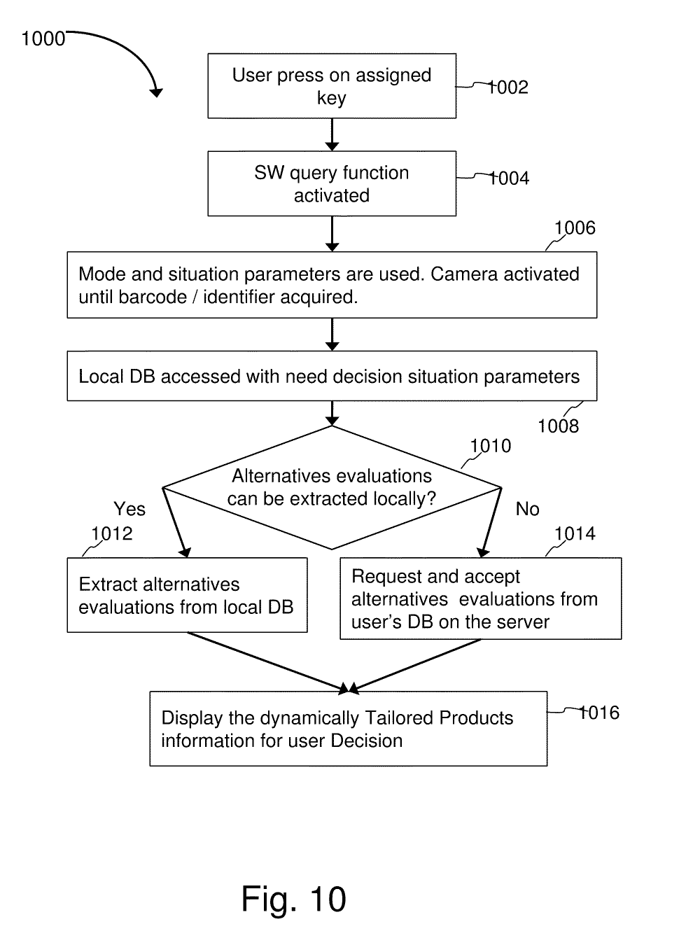

FIG. 10 is a schematic flow chart showing an example of one click method 1000 retrieving Tailored Products information for user Decision, according to embodiments of the present invention;

The user presses on assigned key 1002 activating SW query function 1004, mode and situation parameters are used. Camera is activated until identifier such as a barcode is acquired 1006. The local DB is accessed with need and decision situation parameters 1008 that can be estimated automatically. If alternatives evaluations can be extracted locally 1010 the alternatives evaluations are extracted from local DB 1012, if not then the alternatives evaluations are retrieved from user's DB on the server 1014 through network request and answer. Dynamically Tailored Products information for user Decision is displayed 1016.

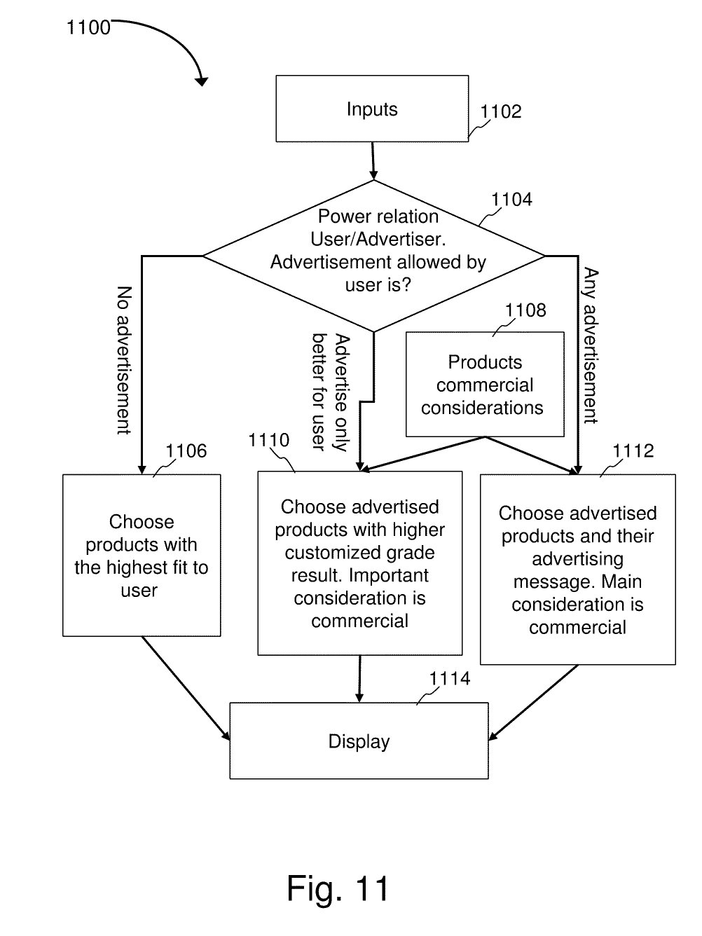

FIG. 11 is a schematic flow chart showing an example method 1100 of producing Alternatives sets with regard to advertisement, according to embodiments of the present invention;

Method 1100 demonstrates how the information on the user's preferences can be used to supply different alternatives sets and messages that are suitable to the user while advertisement considerations are embedded.

Inputs 1102 may include an anchor, location and user preferences. In relation to power relation—User 110 verses Advertiser 192, Advertisement allowed by user 1104, three modes are available. Mode 1, no advertisement—the method 1100 chooses products with the highest fit to user 1106. In the other modes products commercial considerations 1108 is used. Mode 2, advertises only alternatives that are better for the user. the method 1100 chooses advertised products with higher customized grade result. Important consideration is commercial 1110. Mode 3, any advertisement allows the method 1100 to choose advertised products and their advertising message. Main consideration is commercial 1112, the message can be any suitable advantage. Alternatives and messages are displayed 1114.

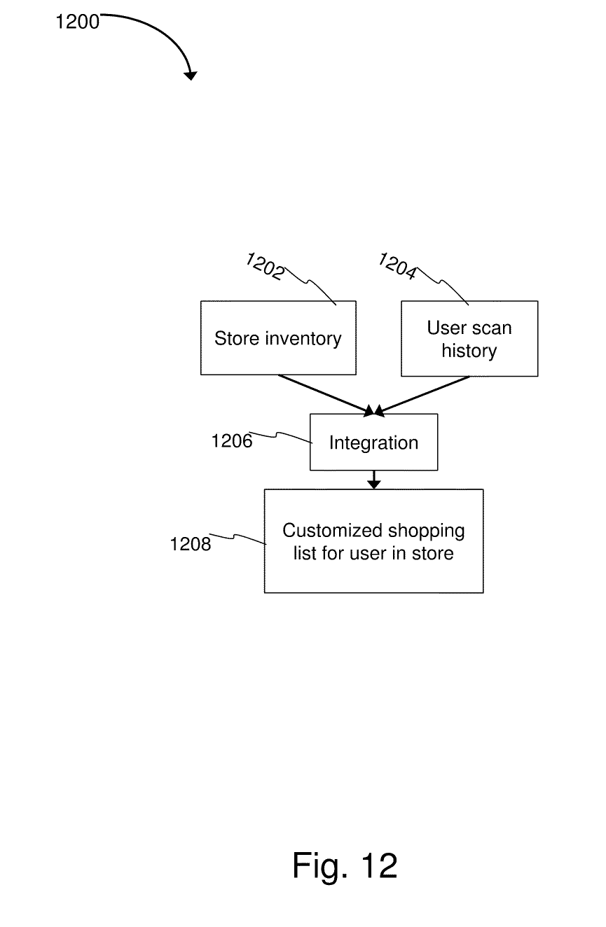

FIG. 12 is a schematic flow chart showing an example method 1200 producing and checking Tailored shopping list, according to embodiments of the present invention;

Store inventory 1202 and user scan history 1204 are integrated 1206 to produce customized shopping list for user in store 1208. In method 1200 user scan history 1204 could be a list of deficiencies in user's inventory. In method 1200 Store inventory 1202 can be replaced by relevant stores' inventories producing Comparison between purchases by cost and product availability.

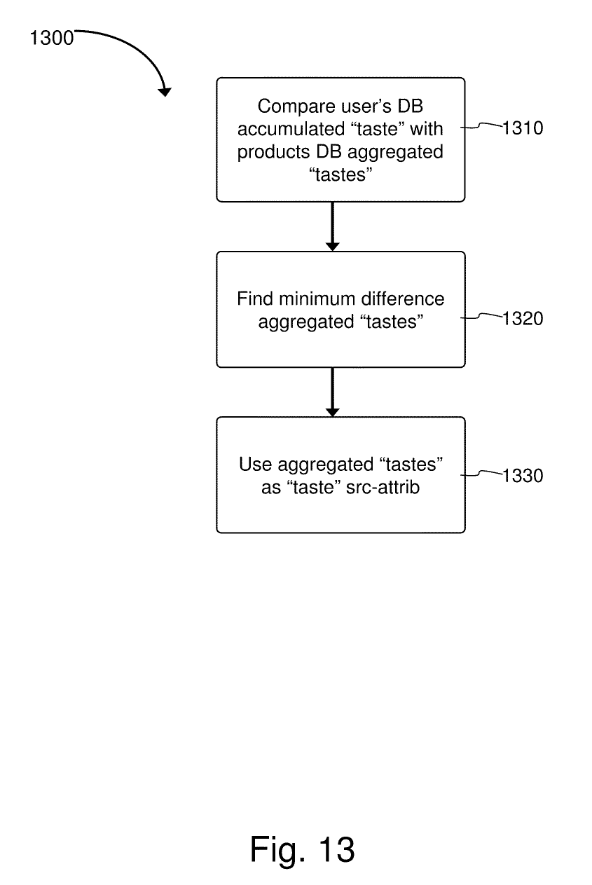

FIG. 13 is a schematic flow chart showing an example method 1300 acquiring personal taste indication sourced attribute, according to embodiments of the present invention; This is an example of using User's DB 136 accumulated history to enhance user preferences algorithm 420.

Comparison of user's DB accumulated “taste” with products DB aggregated “tastes” 1310 is performed to find minimum difference aggregated “tastes” 1320. the found similar aggregated “tastes” are used as “taste” src-attrib 1330 to predict taste evaluation. Aggregated “tastes” are src-attribs that represent the expected taste response of a cluster of people with similar taste responses.

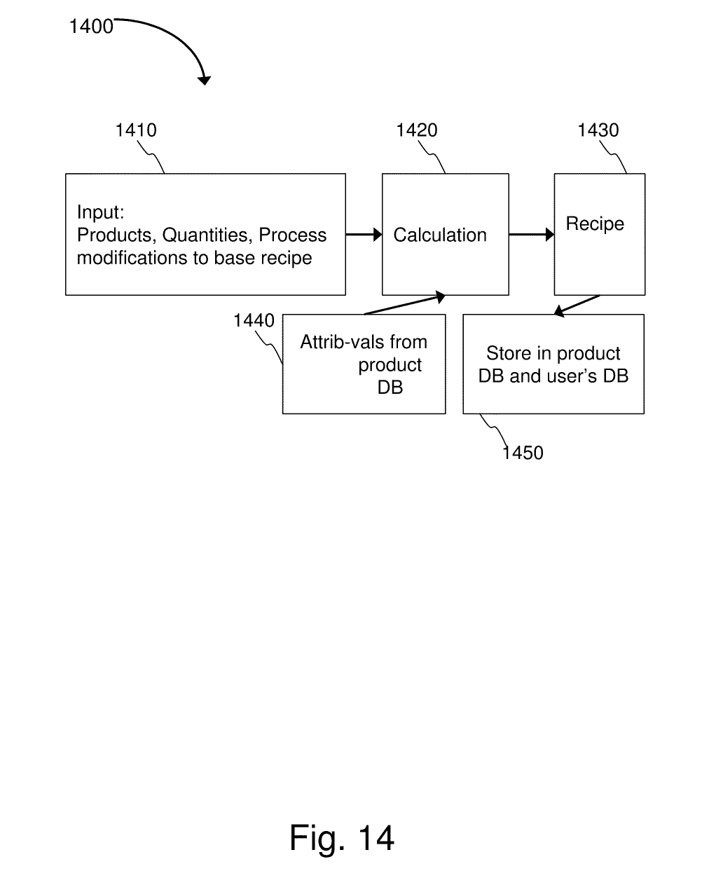

FIG. 14 is a schematic flow chart showing an example method 1400 computing recipe attribute values, according to embodiments of the present invention;

Method 1400 illustrates combination of products creating a recipe that has the attributes similar to other products. Input 1410 can contain: base products, quantities, process or base recipe with modifications. Calculations 1420 can be done by multiplying base products attribute values with the respective quantities and integration of preparation process influences. Attrib-vals of base products are retrieved from product DB 1440. The resulting recipe 1430 has attribute values like other products. The recipe 1430 is Stored in product DB and user's DB 1450.

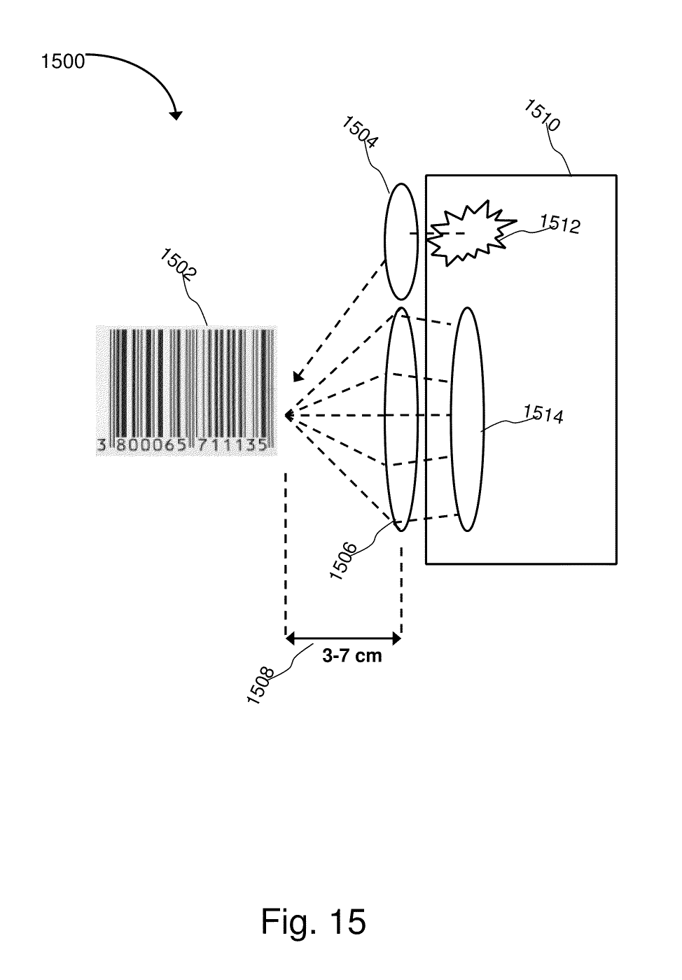

FIG. 15 is an example block diagram of system 1500 enabling mobile phone camera to capture barcode, according to embodiments of the present invention;

When user captures Product barcode 1502, the user places the Mobile phone camera 1510 3-7 centimeters 1508 from the barcode 1502.

Camera flash 1512 flashes, the light is filtered by Flash filter 1504 and the light is dimmed and diffused. The light is reflected from the Product barcode 1502 to the Positive (converging) lens 1506 which reduces the focal distance, in order to enable the camera lens 1514 to focus on the desired distance.

Clarification:

Mobile phone camera 1510 may apply to any mobile device with camera. Flash filter 1504 and Positive (converging) lens 1506 are optional accessories to enable a better capture of the Product barcode 1502. These accessories overcome common difficulties such as reflected light, instability of pictures when taken from a distance. They can be used together or separately in order to improve an existing camera. This means that for each camera, the characteristics of the accessories may vary. For example, a camera with only infinity zoom may need a stronger Positive (converging) lens 1506.

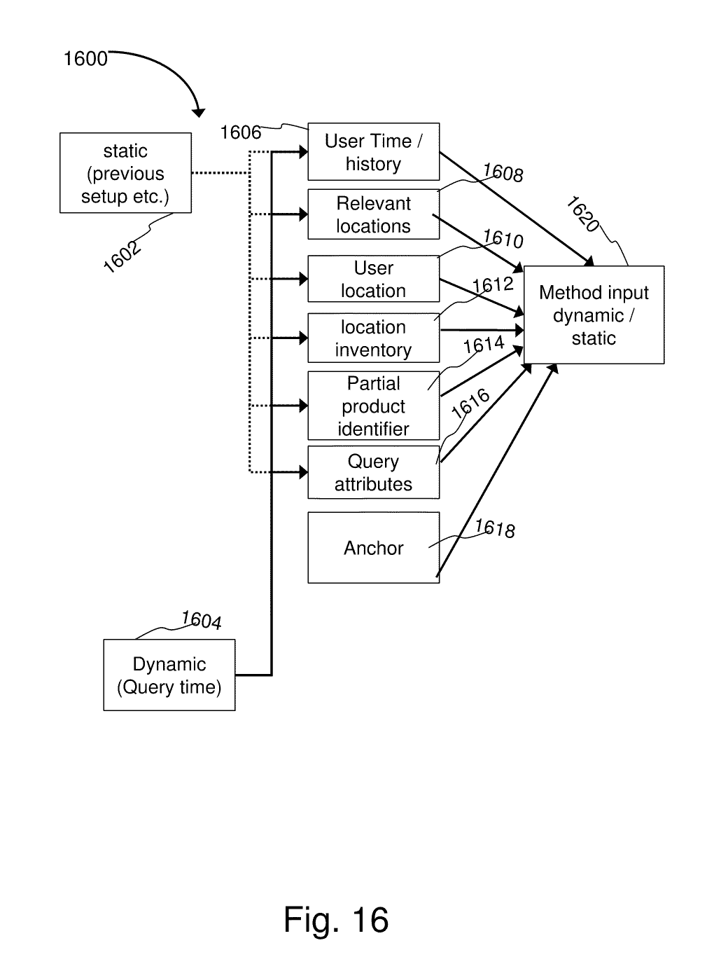

FIG. 16 is a schematic flow chart showing example methods 1600 obtaining input parameters dynamically at query time or statically on setup, according to embodiments of the present invention.

Input parameters can be updated at different frequencies such as static (previous setup etc.) 1602 or at Dynamic (Query time etc.) 1604. Updating level is dependant on user's preferences and the availability of data in the system. User Time/History 1606 is the actual time of query and can have different modes of effect such as “no effect” if the user has general needs, effect relating to preset day schedule such as meal times (for instance—minimal calorie intake after 9 pm), effect as result of actual reported history of behavior entered into the system by the user (for instance—a diabetic person who ate 2 grams of sugar 10 minutes ago or who is in the course of a gym workout). The user chooses which mode he wants to use, according to his behavior habits. Relevant stores (or any location) 1608 can be determined at setup by distance from the users home to work for instance, or by identifying certain preferred or frequent locations using identifiers such as store phone numbers or names. Relevant locations 1608 can be dynamically chosen by distance from the current location (for instance, GPS location). A single relevant location 1608 can be chosen dynamically by choosing from list or current GPS location. User location 1610 can be static (route from home to work for instance) or dynamic (for instance GPS location or location of store chosen from the relevant locations list 1608). Location's inventory 1612 can have different levels of frequency of updating and detailing (For instance, store chain inventory, potential store inventory, in stock inventory, maximum price, current price including sale price). When using Partial product identifier 1614 such as voice recognition of name or text recognition from photo capture, the list of options can be retrieved from a static list such as all products or scanned products, or from a dynamic list such as inventory in current store. Anchor 1618 is an indication to the need that is currently being addressed by the user using the method. The Anchor may be a product name or barcode, a product category, a “need” name (such as a situation, stimulation) with or without it's level, eating instance name (such as breakfast, lunch etc.), time (times of meals, insulin injection etc.). Query attributes 1616 such as use static or dynamic user Time/History 1606 can be statically predefined or can be dynamically chosen by user (as example at purchase the consumption history is irrelevant, yet on consumption decision the dynamic consumption history may be relevant). These parameters become Method input in a dynamic/static manner 1620. Some of the dynamic parameters 1604 such as locations inventories used in the pre-calculations other may require query time adjustment algorithm.

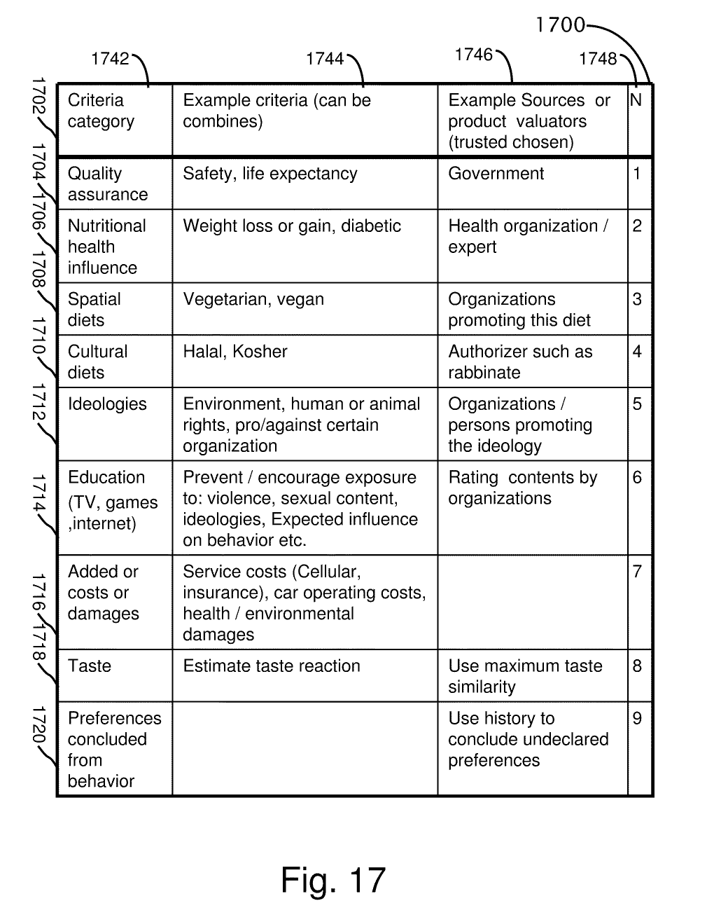

FIG. 17 is a table diagram 1700 showing examples of criteria and corresponding information sources, according to embodiments of the present invention.

Line 1702 is columns headlines. In each of the other lines 1704 to 1720 there is criteria category in column 1742 and it's corresponding example criteria in column 1744, example sources or product evaluators (trusted chosen) in column 1746, serial number “N.” in column 1748. Each line refers to criteria category 1742: quality assurance 1704, nutritional health influence 1706, special diets 1708, cultural diets 1710, Ideologies 1712, Education (TV programs, websites, games etc.) 1714, Added or total costs or damages 1716, Taste 1718 and preferences concluded from behavior 1720.

Following are some examples to illustrate the uses. Quality assurance 1704 Example criteria: Safety, life expectancy, authorization by organizations (including governmental), service quality, high end etc. Example sources: Government and private standardization organizations etc.

Nutritional health influence 1706 Example criteria: Weight loss or gain, diabetic, satiation long or short term, deficiency/excess of nutrient/s, body building/trimming, osteoporosis, allergy/Sensitivity to ingredient/s, ingredients/nutrients/processes believed to be harmful etc. Example sources: Health organization/doctor/dietitian calculating from other data, Health experts etc. Special diets 1708, Example criteria: Vegetarian, vegan, raw vegan, expert's diets (Atkins) etc. Example sources: Organizations/persons promoting this diet. Cultural diets 1710 Example criteria: Halal, Kosher etc.

Example sources: Authorizer such as rabbinate etc. Ideologies 1712 Example criteria: Environment friendliness, human/animal rights, child labor, pro/against certain organization etc. Example sources: Organizations/persons promoting the ideology. Education (TV programs, websites, games etc.) 1714 Example criteria: Prevent/encourage exposure to: violence, sexual content, ideologies, behaviors etc. Expected influence on behavior/nature: violence, hypertension, ADHD, consumerism, humor, philanthropy, xenophobia, depression etc. Example sources: Private/governmental organizations or persons rating the materials. Added or total costs or damages 1716 Example criteria: Service costs (cellular, insurance etc.), car operating costs, health/environmental damages, service costs etc. Taste 1718 Example criteria: Estimate taste reaction Example sources: Use aggregated taste with maximum similarity. Preferences concluded from behavior 1720 example sources: Use history to conclude undeclared preferences.

As used herein in the specification and in the claims section that follows, the term “Product” and the like refer to a Product, service or combination (in a broader sense can mean consumption action).

As used herein in the specification and in the claims section that follows, the term “Alternatives” and the like refer to List of products relevant to a decision instance.

As used herein in the specification and in the claims section that follows, the term “Decision” and the like refer to the comprise a combination of the user preferences with the relevant local alternatives and the Anchor.

As used herein in the specification and in the claims section that follows, the term “Anchor” and the like refer to an indication to the need that is currently being addressed by the user.

As used herein in the specification and in the claims section that follows, the term “Preferences” and the like refer to An algorithm that estimates a value for the utility to the user based on attributes values of a product. Using trusted relevant data.

As used herein in the specification and in the claims section that follows, the term “Tailored” and the like refer to An approximation of the utilities of a set of products for a decision instance. Input comprises of personal preferences, situation parameters (anchor, location).

As used herein in the specification and in the claims section that follows, the term “Location” and the like refer to Store (frequent stores), home, work, restaurant (restaurant chain). May be identified by automatic (GPS, time) or chosen from frequent list.

As used herein in the specification and in the claims section that follows, the term “Inventory” and the like refer to approximated inventory in a location. In the food example it may be supermarket inventory, home inventory or relevant take-aways at work.

As used herein in the specification and in the claims section that follows, the term “Attrib-val” and the like refer to A value assigned to a product to estimate it's attribute. Example 5 grams sugar in 100 grams, 5 is the value, “sugar in 100 grams” is the attribute.

As used herein in the specification and in the claims section that follows, the term “Src-Attrib” and the like refer to the a product attribute values list with added information—Source, relations with other Src-Attribs (sub-sources, certifiers). Example—grams of sugar in 100 grams of each product published by the USDA. The source is USDA and the attribute is “grams of sugar in 100 grams”.

As used herein in the specification and in the claims section that follows, the term “Product evaluator” and the like refer to An organization or person providing one or more Src-Attribs

As used herein in the specification and in the claims section that follows, the term “Customizing expert” and the like refer to An organization or person, that sets up the user's preferences and DB. In the health example it may be: Health organization (Insurer, provider), health expert (Medical doctor, dietitian), an acquaintance etc.

As used herein in the specification and in the claims section that follows, the term “DB” and the like refer to a data base or knowledge base.

As used herein in the specification and in the claims section that follows, the term “IF” and the like refer to an Interface.

As used herein in the specification and in the claims section that follows, the term “SW” and the like refer to Software.

The invention being thus described in terms of several embodiments and examples, it will be obvious that the same may be varied in many ways. Such variations are not to be regarded as a departure from the spirit and scope of the invention, and all such modifications, as would be obvious to one skilled in the art.

What is claimed is:

1. A method of providing tailored alternatives' evaluations to a user regarding said decision instance, said method comprising:
portable device containing input means, communication means, display means, computational abilities;
obtaining decision identifiers, said identifiers comprise location, anchor and user identifier;
extracting tailored alternatives evaluations, said alternatives expected to be available in location inventory, substitution to anchor, alternatives' attributes, meeting user preferences;
displaying personalized evaluation of alternatives, said evaluation being calculated using user preferences adapted to decision situation;
a prior setup using user attributes resulting in user preferences, databases updates as result of new data.

2. The method as set forth in claim 1, wherein said location identifier acquiring comprising: automatically acquiring and input by user.

3. The method as set forth in claim 1, wherein said anchor is automatically acquired; wherein said automatic acquiring comprise use of time, place, regular habits.

4. The method as set forth in claim 1, wherein said anchor is a food product.

5. The method as set forth in claim 4, wherein said food attributes comprise macronutrients, salt quantities,
said evaluations estimate the effect of the attributes on health benefit of users suffering from diabetes, overweight, cardio vascular disorders.

6. The method as set forth in claim 1, wherein said anchor is acquired using input means; input means being recognition of image from camera, voice recognition, text typing, choice from list.

7. The method as set forth in claim 1, wherein said anchors are a product barcodes, usda nutritional database identifiers.

8. The method as set forth in claim 1, wherein said displayed personalized evaluation is the tailored evaluation.

9. The method as set forth in claim 1, wherein said displayed information includes links to further operations on alternatives,
further operations comprise receiving detailed information, alternative's detailed information, choosing an alternative or purchasing.

10. The method as set forth in claim 1, wherein said setup is done by customization expert.

11. The method as set forth in claim 10, wherein said customization expert is a health expert,
health customization experts are health insurers, health providers, other health organizations, medical doctors, dietitians, health leaders.

12. The method as set forth in claim 10, wherein said setup is done automatically or semi automatically using existing user's computerized data that is available to the customization expert, wherein part the data remains only available to the customization expert.

13. The method as set forth in claim 1, wherein said user preferences is an algorithm that estimates the influences of the product attributes on the user's utility.

14. The method as set forth in claim 1, wherein said preferences include updatable user's database wherein part of said user's database is sent to said portable device,
said portable user's database comprise expected frequent locations estimated inventories.

15. The method as set forth in claim 1, wherein part of said user attributes remains secret, accessible only to the executor of the said setup.

16. The method as set forth in claim 1, wherein said personalized evaluation is personalized to a cluster of users.

17. A system comprising:
a portable devise, said device comprising input means, display means, computation means, dedicated software, memory, means of communications;
remote computers, said remote computers comprise database, customizing interface, means of communication with portable device;
said remote computers are used for at least user setup and update, to send part of the results to portable device;
said remoter computers also return online information as a result of decision identifiers sent by said portable device;
portable device is used by user to obtain decision identifiers, extract tailored alternatives evaluations, display personalized evaluation of alternatives.

18. The system set forth in claim 17, wherein database comprise user database, estimated locations inventory database, users' database, sourced-attributes database.

19. The system set forth in claim 17, wherein interface comprise customizing experts interface, product evaluators interface, user's interface, advertisers interface.

20. A system comprising:
input output device, said input output device being separate and distant from remote computer, said input output device being personal computer equivalent, said input output device comprising:
arena remote interface, said remote interface operations comprising part of the operations provided by sources-attributes arena;
one or more remote computers, said remote computers comprising:
sources-attributes arena, comprising:
sources-attributes database, said sources-attributes database comprising a set of sourced-attributes;
arena remote interface, said arena remote interface operations comprising search sourced-attributes, use sourced-attribute, relate to sourced-attribute;
sourced-attribute, comprising:
header comprising source, claimed essence, feed algorithm, relations;
set of attribute-values, said attribute-value comprising value, product identifier, said product identifier is unique in the sourced-attributes arena.
